(19) United States
(12) Patent Application Publication
(10) Pub. No.: US 2024/0017289 A1
(43) Pub. Date: Jan. 18, 2024

(54) Extendable Roller Paint Applicator Device

(71) Applicant: James Warren, Centaila, MO (US)

(72) Inventor: James Warren, Centaila, MO (US)

(21) Appl. No.: 17/866,518

(22) Filed: Jul. 17, 2022

(51) Int. Cl. B05C 17/02; B25G 1/04

(52) U.S. Cl. CPC B05C 17/0205; B05C 17/0245; B25G 1/04

(57) ABSTRACT

An extendable roller paint applicator device for extending the roller to inaccessible surfaces includes a hand grip. The hand grip has a painting surface and an extension surface. A stem is positioned upon the painting surface of the hand grip. The stem has a distal end and a proximal end relative to the hand grip. Furthermore, the distal end of the stem has a bend. A roller enwraps the bend of the stem and is coupled to the bend of the stem by a pivot. The pivot rotates the roller when pushed against a surface. A brush is positioned around the roller. Additionally, an extender is positioned upon the extension surface of the hand grip. The extender increases a length of the hand grip relative to the roller.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to roller paint applicator device and more particularly pertains to a new roller paint applicator device for extending the roller to inaccessible surfaces.

### (2) Description of Related Art Including Information Disclosed Under 37 CFR 1.97 and 1.98

The prior art relates to roller paint applicator devices. The prior art relates to a variety of roller paint applicator devices configured for applying paint to surfaces by a rotating brush. Known prior art lacks a roller paint applicator device configured for applying paint to inaccessible surfaces by using a threaded attachable extender.

### BRIEF SUMMARY OF THE INVENTION

An embodiment of the disclosure meets the needs presented above by generally comprising a hand grip having a cylindrical shaped body. The hand grip has a painting surface and an extension surface. A stem is positioned upon the painting surface of the hand grip. The stem has a distal end and a proximal end relative to the hand grip. Furthermore, the distal end of the stem has a bend. A roller is enwrapped upon the bend of the stem and is coupled to the bend of the stem by a pivot. The pivot is configured for rotating the roller when pushed against a surface. A brush is positioned around the roller. Additionally, an extender is positioned upon the extension surface of the hand grip. The extender is configured for increasing a length of the hand grip relative to the roller.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom isometric view of an extendable roller paint applicator device according to an embodiment of the disclosure.

FIG. 2 is an exploded view of an embodiment of the disclosure.

FIG. 3 is a front view of an embodiment of the disclosure.

FIG. 4 is a left side view of an embodiment of the disclosure.

FIG. 5 is an isometric top view of an embodiment of the disclosure.

FIG. 6 is an in-use view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

### DETAILED DESCRIPTION OF THE INVENTION

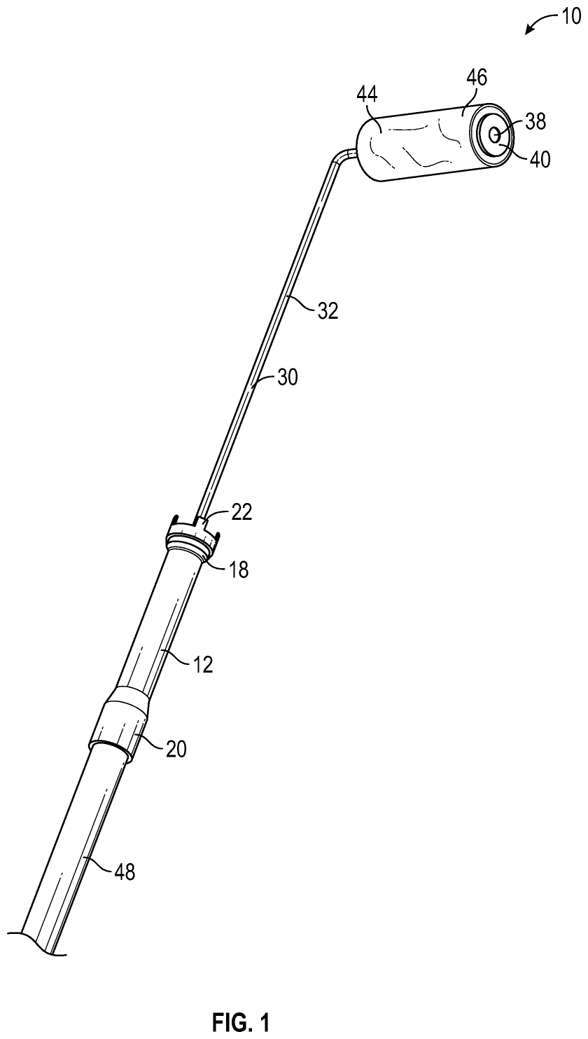

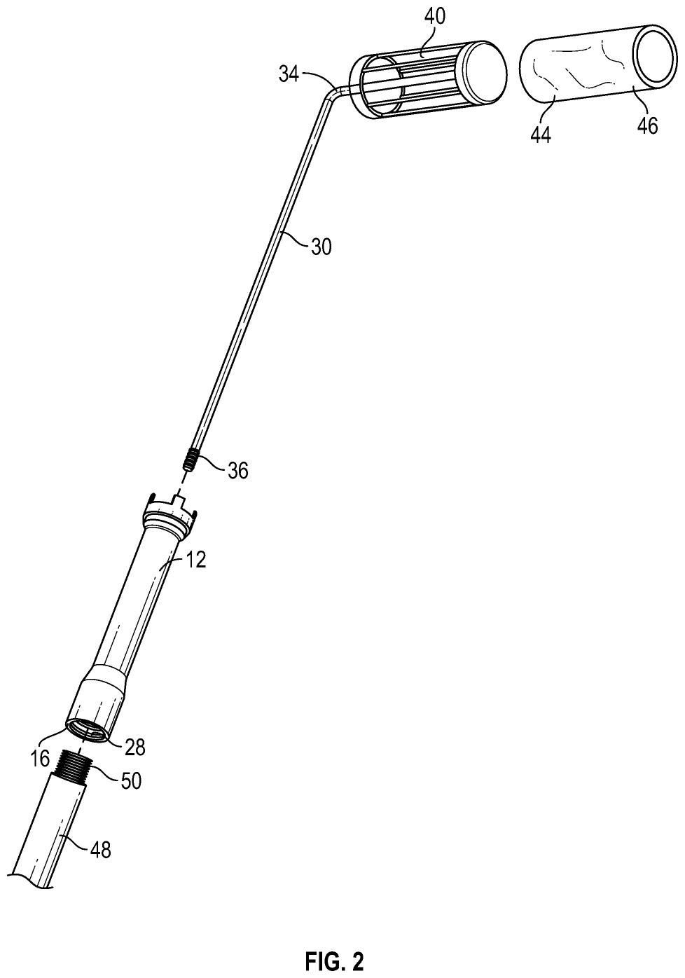

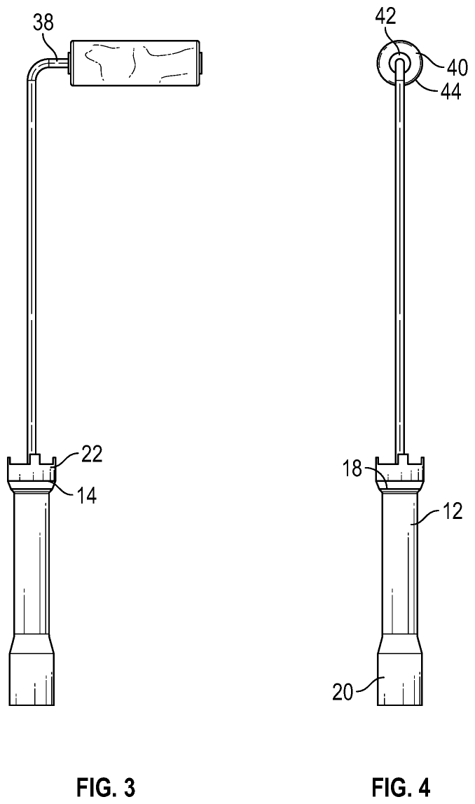

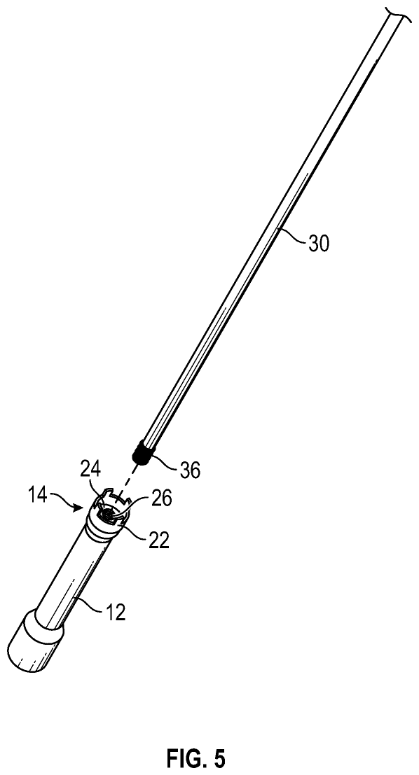

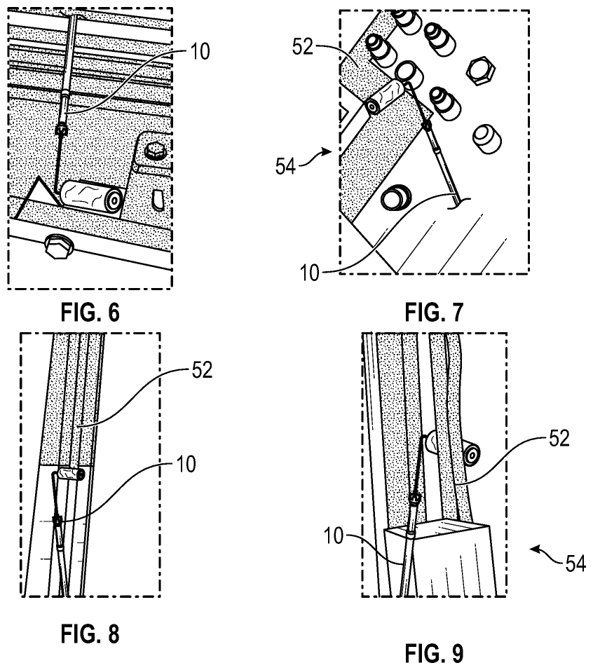

With reference now to the drawings, and in particular to FIGS. 1 through 9 thereof, a new roller paint applicator device embodying the principles and concepts of an embodiment of the disclosure and generally designated by the reference numeral 10 will be described.

As best illustrated in FIGS. 1 through 9, the extendable roller paint applicator device 10 generally comprises a hand grip 12. The hand grip 12 has a cylindrical shaped body. Furthermore, the hand grip 12 has a painting surface 14 and an extension surface 16. The painting surface 14 is configured for being a top end 18 of the hand grip 12, wherein the extension surface 16 is the bottom end 20 of the hand grip 12. The painting surface 14 has a perimeter wall 22 protruding out therefrom. The painting surface 14 has a center 24 and a hole 26 is positioned within the center 24 of the painting surface 14. Additionally, the hole 26 has internal threading. The extension surface 16 has a socket 28 protruding inward towards the hand grip 12. The socket 28 defines a space for an insert to be nested within. In addition, the socket 28 has internal threading.

A stem 30 is positioned upon the painting surface 14 of the hand grip 12. The stem 30 is a metal material 32, wherein the property of the metal material 32 provides structure and durability to the stem 12. The stem 12 has a distal end 34 and a proximal end 36 relative to the hand grip 12. The proximal end 36 has external threading, wherein the proximal end 36 of the stem 12 is complementary to the hole 26 of the painting surface 14 of the hand grip 12. The stem 30 engages by threading to the hole 26 of the painting surface 14 of the hand grip 12. The distal end 34 of the stem 30 has a bend 38 positioned perpendicular relative to the stem 30. A range of length from the bend 38 of the stem 30 to the extension surface 16 of the hand grip 12 is configured for being from 32 centimeters to 38 centimeters.

A roller 40 is enwrapped upon the bend 38 of the stem 30. The roller 40 has a cylindrical shaped body and is coupled to the bend 38 of the stem 30 by a pivot 42. The pivot 42 is configured for rotating the roller 40 when the roller 40 is pushed against a narrowed surface 52. A brush 44 is positioned around the roller 40 and the brush 44 is configured for applying paint in the narrowed surface 52. The brush 44 is a microfiber material 46 configured for retaining paint subsequent to applying paint to the narrowed surface 52. The roller 40 and the brush 44 are configured for having a range of length from 3 centimeters to 4 centimeters.

An extender 48 is the insert of the socket 28 positioned upon the extension surface 16 of the hand grip 12. An end 50 of the extender 48 has external threading, wherein the end 50 of the extender 48 is complementary to the socket 28 of the hand grip 12. The end of the extender 48 is configured for engaging by threading to the socket 28 of the extension surface 16 of the hand grip 12. The extender 48 is configured for increasing a length of the hand grip 12 relative to the roller 40 wherein the roller 40 is able to reach an inaccessible surface 54 not reachable without the extender 48.

In use, the brush 44 enwrapped around the roller 40 is saturated in paint, wherein the microfiber material 46 of the brush 44 will retain the paint around the brush 44. The user can attach the extender 48 to the extension surface 16 of the hand grip 12 to increase the length of the hand grip 12 to reach the inaccessible surface 54. The user forces of the roller 40 against the narrowed surface 52, where the pivot 42 of the roller 40 rotates the roller 40 and brush 44 to apply paint to the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A paint roller extension device configured for extending a paint roll to a longer length, the paint roller extension device comprising:
a hand grip having a cylindrical shaped body, said hand grip having a painting surface and an extension surface;
a stem being positioned upon said painting surface of said hand grip, said stem having a distal end and a proximal end relative to said hand grip, said distal end of said stem having a bend;
a roller being enwrapped upon said bend of said stem, said roller being coupled to said bend of said stem by a pivot, said pivot being configured for rotating said roller when pushed against a surface, a brush being positioned around said roller, said brush being configured for applying paint in narrowed surfaces; and
an extender being positioned upon said extension surface of said hand grip, said extender being configured for increasing a length of said hand grip relative to said roller.

2. The paint roller extension device of claim 1, further comprising said painting surface configured for being a top end of said hand grip, said painting surface having a perimeter wall protruding out from said painting surface.

3. The paint roller extension device of claim 2, further comprising said painting surface having a center, a hole being positioned within said center of said painting surface, said hole having internal threading.

4. The paint roller extension device of claim 3, further comprising said extension surface having a socket protruding inward towards said hand grip, said socket defining a space for an insert to be nested within, said socket having internal threading.

5. The paint roller extension device of claim 1, further comprising said stem being a metal material wherein a property of said metal material providing structure and durability to said stem.

6. The paint roller extension device of claim 4, further comprising said proximal end having external threading, said proximal end of said stem being complementary to said hole of said painting surface of said hand grip wherein said stem engages by threading to said hole of said hand grip.

7. The paint roller extension device of claim 1, further comprising said bend being positioned perpendicular relative to said stem.

8. The paint roller extension device of claim 1, further comprising said roller having a cylindrical shaped body.

9. The paint roller extension device of claim 1, further comprising said brush being a microfiber material, said microfiber material being configured for retaining paint subsequent to applying paint to a surface.

10. The paint roller extension device of claim 6, further comprising said extender having an end, said end having external threading, said end being complementary to said socket of said hand grip wherein said end engaging by threading to said socket of said hand grip.

11. A paint roller extension device configured for extending a paint roll to a longer length, the paint roller extension device comprising:
a hand grip having a cylindrical shaped body, said hand grip having a painting surface and an extension surface, said painting surface configured for being a top end of said hand grip, said painting surface having a perimeter wall protruding out from said painting surface, said painting surface having a center, a hole being positioned within said center of said painting surface, said hole having internal threading, said extension surface having a socket protruding inward towards said hand grip, said socket defining a space for an insert to be nested within, said socket having internal threading;
a stem being positioned upon said painting surface of said hand grip, said stem being a metal material wherein a property of said metal material providing structure and durability to said stem, said stem having a distal end and a proximal end relative to said hand grip, said proximal end having external threading, said proximal end of said stem being complementary to said hole of said painting surface of said hand grip wherein said stem engages by threading to said hole of said hand grip, said distal end of said stem having a bend, said bend being positioned perpendicular relative to said stem;
a roller being enwrapped upon said bend of said stem, said roller having a cylindrical shaped body, said roller being coupled to said bend of said stem by a pivot, said pivot being configured for rotating said roller when pushed against a surface, a brush being positioned around said roller, said brush being configured for applying paint in narrowed surfaces, said brush being a microfiber material, said microfiber material being configured for retaining paint subsequent to applying paint to a surface; and
an extender being positioned upon said extension surface of said hand grip, said extender having an end, said end having external threading, said end being complementary to said socket of said hand grip wherein said end engaging by threading to said socket of said hand grip, said extender being configured for increasing a length of said hand grip relative to said roller.
